(19) United States
(12) Patent Application Publication
(10) Pub. No.: US 2023/0183386 A1
(43) Pub. Date: Jun. 15, 2023

(54) Process for treating biomass consisting of citrus pastazzo

(71) Applicant: Politecnico di Milano, Milano MI (IT)

(72) Inventors: Andrea MELE, Milano MI (IT); Monica FERRO, Milano MI (IT); Greta COLOMBO DUGONI, Milano MI (IT); Rosario DISPENZA, Milano MI (IT)

(21) Appl. No.: 17/926,465

(22) PCT Filed: May 20, 2021
(86) PCT No.: PCT/IB2021/054370

§ 371 Date: Nov. 18, 2022

(30) Foreign Application Priority Data
May 22, 2020 (IT) 102020000012019

(51) Int. Cl. C08B 37/00

(52) U.S. Cl. CPC C08B 37/0048; C08B 37/0057

(57) ABSTRACT

Process for the treatment of biomass comprising dried and pulverized citrus pulp, said process comprising the following steps:
A. mixing the biomass with a process solvent selected from a eutectic solvent comprising a hydrogen bond acceptor and a hydrogen bond donor, an ionic liquid and a mixture of said eutectic solvent and said ionic solvent, and precipitation of cellulose residues;
B. separation of the insoluble cellulose residues precipitated in step A;
C. separation of the hemicellulose and the pectin from the process solvent;
wherein in the aforesaid step C. of the separation of hemicellulose and pectin is performed through the addition of a lower alcohol and water, thus allowing the precipitation of the hemicellulose and the pectin and their subsequent separation with conventional techniques from the liquid phase comprising process solvent, organic solvent and possibly water.

### FIELD OF THE INVENTION

The present invention relates to a process for the treatment and recovery of cellulosic products from biomass consisting of citrus pulp.

### BACKGROUND

The treatment of biomass to obtain products with high industrial value is fully part of the concept of circular economy which envisages an economy designed to be able to regenerate itself. In a circular economy, material flows are of two types: biological ones, capable of being reintegrated into the biosphere, and technical ones, destined to be revalued without entering the biosphere.

For example, “citrus pulp” is a well-known biomass consisting of citrus peels, and originates as a by-product of the food processing industry consisting of the waste from squeezed lemons and oranges. The citrus pulp has several uses, the best known concerning the organic soil fertilisation, livestock feed and the extraction of pectin, a thickening polysaccharide naturally present in fruit, and widely used in the production of jams. The citrus pulp can be used fresh or dried, after pressing, a process that cuts the costs associated with storage and transport. In recent years, thanks to scientific progress, the citrus pulp is also being used as biomass for electricity production.

From a chemical-physical point of view, the citrus pulp consists of residues of peels (60-75%), of pulp (30-35%) and seeds (on average 0-9% but depending on the quality of processed oranges and lemons. The citrus pulp is mainly composed of insoluble polysaccharides such as pectin and cellulose, of simple sugars, of acids, especially citric and malic, of lipids such as oleic, linoleic and palmitic acids, of minerals such as calcium and potassium, of essential oils, flavonoids, carotenoids and limonoids, enzymes, vitamin C to B complex.

Therefore, it is known to treat biomass in order to obtain high value-added products such as for example cellulose, hemicellulose and pectin.

As far as cellulose is concerned, its best known application is the production of paper. However, cellulose is also widely used in the pharmaceutical sector (production of gauze and coatings capable of modulating the release of active ingredients from the tablet), cosmetics (gels, stabilisers, filming agents, toothpastes), textiles (rayon, lyocell), etc. Natural cellulose sponges can be used in many ways in the chemical industry: shipbuilding (to seal ducts in bulkheads), petrochemical industry (filtration processes), cooling systems (moisture absorption), surface cleaning cloths. As cellulose is insoluble in water, it is transformed into Carboxy-Methyl-Cellulose (CMC), Cellulose acetate or nitrocellulose through a chemical reaction in order to be used industrially in certain applications. CMC is produced by introducing the carboxymethyl substituent, which transforms cellulose, insoluble in aqueous solvents, into soluble CMC. CMC is used in a wide range of fields, mainly due to its thickening (increases the viscosity of a solution) and floating (keeps solid particles suspended in solution) capacities, as well as its adhesive and water retention capacities. The length of the CMC molecule (number of glucose units making it up) influences the viscosity of the solution and, therefore, the field of application. The main sectors in which CMC is used are: detergents, oil drilling, ceramics, paper industry, textile industry, paints and varnishes, food industry, cosmetics, pharmaceuticals, pet food. Cellulose acetate, on the other hand, is produced by reacting cellulose with acetic anhydride to give a very versatile glossy polymer. It is often called “artificial silk” and is used for the textile industry. It is mainly used in the manufacture of spectacle frames and sunglasses. It can also be produced in thin transparent sheets, which are used to make protective masks, lamp shades and theatre projectors. Finally, nitrocellulose is the nitrate ester of cellulose. Formerly used for camera flashes, it is now mainly used in the manufacture of paints and enamels. It is used in protein analysis (Western blot), magic tricks and as a propellant for pistol and rifle cartridges. Hemicellulose is the name of a family of poorly soluble polysaccharides, closely associated with cellulose, from which it can be extracted. Both cellulose and hemicellulose are the main components found in dietary fibre, edible substances of plant origin that are not normally hydrolysed by enzymes secreted by the human digestive system. Hemicellulose is a low molecular weight polysaccharide (oligosaccharide) with an irregular composition. In contrast to cellulose, whose linear molecule is made up of glucose-only units, hemicellulose consists of different sugars with a branched, non-fibrous structure. The main characteristic of hemicellulose is its tendency to absorb water molecules when it comes into contact with water. In addition, it is responsible for a number of fibre properties, properties derived from the chemical structure. In nature, hemicellulose is amorphous and has adhesive properties. In fact, it tends to cement or take on a typical horny appearance when dehydrated. Hemicellulose is usually difficult to separate from cellulose. By reaction with H₂SO₄ it leads to the formation of furfural. The latter is used as a solvent in petrochemistry to extract dienes (such as those used to produce synthetic rubber) from other hydrocarbons. Hemicellulose is also used for the preparation of solid resins, for the production of fibreglass for aeronautical components and for brakes. In addition, hemicellulose can also be used for the production of Nylon, with a process that was already implemented in the past but which, due to the difficult separation from cellulose, led to low yields and was industrially expensive.

Finally, as regards pectin, this is a natural product found in the cell wall of all higher plants and is used for its gelling, thickening and stabilising properties in the food, cosmetics and pharmaceutical industries. Pectin is a complex polysaccharide consisting of esterified D-galacturonic acid residues joined by alpha chains (1-4). In the natural product the acid groups are esterified with methoxyl groups. In contrast, the commercial pectins are classified according to the content of methoxyl groups. The degree of esterification is defined as the ratio of methoxylated groups to free acid groups on the pectin molecular chain. This ratio, called D.M., is a very important value for pectin as it influences the capacity and speed thereof of gel formation.

Pectin is generally obtained by acid extraction from plant tissue, usually citrus peel and/or apple peel. Each fruit has a percentage of pectin that depends on the species and its degree of ripeness. Pectin cements the plant cell walls, holding them together and giving the fruit a crunchy texture. As the fruit ripens, this bond dissolves and the fruit loses consistency.

The following classification is based on the average amount of pectin contained in different types of fresh fruit:

High pectin content: lime, lemon, orange and apple;

Medium pectin content: apricot and blackberry;

Low pectin content: cherry, peach and pineapple.

It should be noted that pectin is used as a gelling agent in a large number of fruit-based products, such as jams, marmalades, gummy sweets, fruit preparations for yoghurt, desserts, fruit-based fillings and bakery creams, taking on the name E440. Pectin is also used to improve the consistency and stability of pulps in juice-based drinks and acts as a stabiliser of the proteins in acidic environments (e.g. in products containing milk and fruit juice). In fruit jellies and gummy sweets, the pectin gives the product a suitable gel structure with excellent cutting properties.

Finally, pectin finds application in the pharmaceutical and cosmetic sector. In fact, the different pectins have been proven as: anti-diarrhoeal and in the treatment of hypercholesterolemia.

Various processes for the treatment of biomass coming from citrus peel waste are known from the state of the art. For example, the process described in the scientific article Bruinhorst et al, Nat Prod Chem Res 2016, 4:6 DOI: 10.4172/2329-6836.1000242. In particular, this process employs DES solvent (Deep Eutectic Solvent) consisting of glycolic acid and choline chloride to study the deterioration effects on biomass. In detail, the above-mentioned solvent is applied to the orange peels separated into albedo (the part containing white spongy cellulose, starch and pectin, flavonoids, amino acids and vitamins) and flavedo (the part responsible for the typical orange colour and smell as it incorporates the essential oil glands and lignin) in order to assess the disintegration of the parts without carrying out any precipitation and/or separation of any precipitates.

The prior art described above presents a number of problems, as it does not allow the complete separation of the constituent elements of the biomass, in particular the hemicellulose, cellulose and pectin. In addition, the known processes do not allow for the complete separation of the eutectic solvent from the reaction products and consequently recycling the used eutectic solvent is problematic.

### SUMMARY OF THE INVENTION

The Applicant has found a method for the treatment of biomass capable of overcoming the drawbacks of the prior art so as to enable large-scale and continuous processing of the biomass, resulting in higher purity end products.

An object of the present invention is therefore a process for the treatment of biomass consisting of citrus pulp comprising the following steps:

A. mixing the biomass consisting of dried and pulverized citrus pulp with a process solvent selected from a eutectic solvent consisting of a hydrogen bond acceptor and a hydrogen bond donor, an ionic liquid and a mixture of said eutectic solvent and said ionic solvent, and precipitation of cellulose residues;

B. separation of the insoluble cellulosic residues precipitated in step A.;

C. separation of the hemicellulose and the pectin from the process solvent

wherein step C. of separation of the hemicellulose and pectin is performed through the addition of a lower alcohol and water, thus allowing the precipitation of the hemicellulose and the pectin and their subsequent separation with conventional techniques from the liquid phase comprising process solvent, organic solvent and possibly water.

In particular, this process makes it possible to obtain products with high added value in a simple and economical way. Advantageously, the steps according to the present invention allow the biomass components to be separated with a high degree of purity, at the same time allowing a more efficient separation of the solvent initially used from the reaction mixture in order to be recycled in the process.

### LIST OF FIGURES

FIG. 1: Block diagram representing the process for the treatment of biomass according to a preferred embodiment of the present invention.

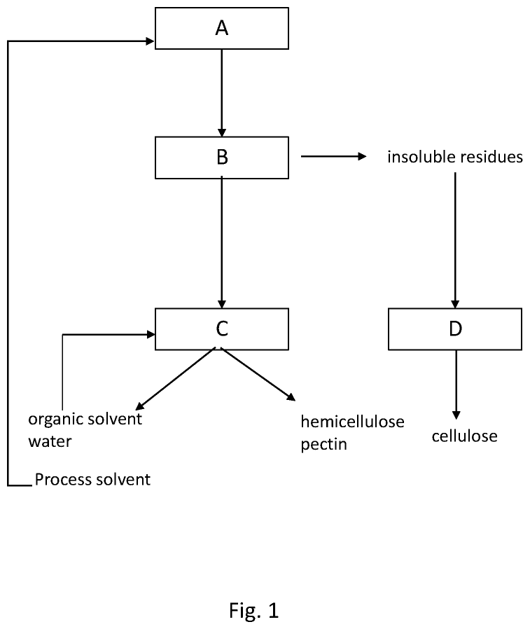

### DETAILED DESCRIPTION

For the purposes of the present invention, “citrus pulp” has been dehydrated and pulverized before being used in the process of the invention. The main components of this biomass are cellulose (25-30%), hemicellulose (10-15%) and pectin (15-20%).

For the purposes of the present invention, the process solvent may comprise a eutectic solvent, an ionic liquid or a combination of the eutectic solvent and the ionic liquid.

For the purposes of the present invention, eutectic solvents refer the so-called deep eutectic solvents or DES. In other words, it is a combination of a hydrogen bond acceptor and a hydrogen bond donor. Preferably in the process of the invention the hydrogen bond acceptor is selected from between choline acetate and choline chloride, while the hydrogen bond donor is selected from urea, glycolic acid, diglycolic acid, citric acid, levulinic acid and imidazole. In a particularly preferred embodiment, the DES used is the combination of choline acetate and urea or choline acetate and glycolic acid or choline acetate.

The production of the eutectic solvent is preferably performed in a temperature range comprised between 20 and 100° C., more preferably between 25 and 90° C., even more preferably between 30 and 80° C., and according to a particularly preferred embodiment at 50° C.

For the purposes of the present invention, by an ionic liquid used as a process solvent it is meant the product resulting from the reaction of:

choline Y⁻+X—H=choline X⁻+YH

where X is the anion of an organic weak acid preferably selected from glycolic acid, citric acid, diglycolic acid, levulinic acid. In particular, the ionic liquid contains choline ion in the presence of the conjugated base of glycolic acid or diglycolic acid or levulinic acid. In a particularly preferred embodiment, the ionic liquid used is choline glycolate.

The ionic liquid formation reaction is preferably performed in a temperature range comprised between 20 and 80° C., more preferably between 20 and 60° C. even more preferably between 20 and 50° C. and according to a particularly preferred embodiment at 25° C. Furthermore, the ratio between the reagents is preferably 1:1.

Preferably, the process solvent used in the process according to the present invention is halogen-free, so that the disposal thereof at the end of industrial processing has a lower environmental impact.

DESs are prepared by simple mixing the two components at room temperature and pressure, reducing preparation costs and production time.

DESs can in turn react to form the above-mentioned ionic liquid. Since the ionic liquid formation reaction is an equilibrium reaction, this explains the fact that the process solvent is a mixture of DES and ionic liquid.

In particular, the mixture of the eutectic solvent and the ionic liquid, when choline acetate is used as the hydrogen acceptor, preferably comprises choline X⁻, acetic acid and eutectic solvent, where the hydrogen bond acceptor and the hydrogen bond donor are preferably halogen-free, the hydrogen bond acceptor is preferably choline acetate and the hydrogen bond donor is preferably selected from: glycolic acid, diglycolic acid, citric acid, levulinic acid and urea, more preferably the hydrogen bond donor is selected from acid glycolic.

According to the present invention the weight ratios between the components of the eutectic solvent, donor and acceptor of hydrogen bonds, preferably are comprised between 1:5 and 5:1, more preferably from 1:3 to 3:1, even more preferably from 1:2 to 2:1 and according to a particularly preferred solution said ratio is 1:1. The molar ratio between the reagents for DESs choline chloride combined with urea or choline acetate combined with urea is preferably 1:2.

For the purposes of the present invention, lower alcohol means a C2-C4 alcohol preferably ethanol or isopropanol, more preferably ethanol.

Advantageously, the lower alcohol added to a solution comprising hemicellulose and/or pectin and the process solvent and optionally water favours the selective precipitation of organic material, preferably hemicellulose and pectin, allowing it to be separated and used in subsequent processing.

According to the present invention, the lower alcohol solubilises the process solvent and possibly water by promoting the precipitation of hemicellulose and pectin.

For the purposes of the present invention, the separation of precipitated hemicellulose and pectin is carried out with conventional techniques such as, for example, filtration, fractional precipitation, or, preferably, centrifugation.

A further advantage of the invention is that the separation of the hemicellulose and pectin from the reaction mixture containing the process solvent facilitates recycling the process solvent and obtaining a mixture of hemicellulose and pectin in a purer form.

In step A. the mixing of the biomass with the process solvent takes place preferably in a temperature range comprised between 15 and 60° C., more preferably between 20 and 50° C. even more preferably between 20 and 40° C. and according to a particularly preferred embodiment at 25° C.

The manufacturing process comprises a step prior to step A. in which the biomass is ground and dried, reducing it to powder. This facilitates mixing with the process solvent and the subsequent separation steps.

Preferably, in step B. any separation of the insoluble cellulosic residues from the mixture containing the process solvent, is carried out with conventional procedures such as, for example, filtration, fractional precipitation, or, preferably, centrifugation.

Step B. of the process according to the present invention provides for the separation of the insoluble material in the process solvent from the mixture comprising the process solvent, hemicellulose, pectin and any other components. In this way in step B. the cellulose is separated from the rest of the mixture comprising the process solvent.

The process preferably comprises a step D. in which the precipitate separated in step B. is washed with water to dissolve any inorganic material and to remove the traces of DES and/or ionic liquid. In particular, the washing is repeated at least from 2 to 10 times, preferably 6 times in order to facilitate the elimination of any residues of the process solvent within the cellulose mixture. Subsequently, step D. provides for centrifuging the aqueous mixture which allows to obtain cellulose with a high degree of crystallinity, eliminating any water residues.

Preferably, the washing water containing residues of the process solvent is recycled in step A.

The cellulose is purified compared to the starting biomass from amorphous substances contained in the biomass, preferably hemicellulose. The degree of purification is expressed as the increase in crystallinity of the cellulose compared to the starting biomass. The crystallinity is measured by powder X-ray diffractometry. In particular, cellulose shows an increase in the degree of crystallinity, compared to the starting biomass, comprised between 4% and 40%, preferably between 5% and 30%.

In other words, the increase in purity of the cellulose in the process according to the present invention is attributable to a more efficient separation of the cellulose from other materials.

In particular, step C., following the addition of ethanol, provides for the separation of the precipitated hemicellulose and pectin from the mixture with conventional techniques, preferably by centrifugation from the eutectic solvent and/or ionic liquid. Preferably, step C of the process according to the present invention provides for the separation of the process solvent, organic solvent and water from the rest of the mixture comprising hemicellulose, pectin and any other residues. In this way, it is possible to recycle the process solvent, water and organic solvent in steps A. and C. respectively.

Laboratory examples are shown below in order to better clarify the different steps of the process according to the invention and the high added value products obtained.

### EXAMPLE 1

In this example, 150 mg of dried and ground citrus pulp and 1.5 g DES choline acetate combined with glycolic acid were used in a 1:1 molar ratio.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

### EXAMPLE 2

In this example, 150 mg of dried and ground citrus pulp and 1.5 g of DES choline chloride combined with urea, in a 1:2 molar ratio, were used.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

### EXAMPLE 3

In this example, 150 mg of dried and ground citrus pulp and 1.5 g DES choline acetate combined with urea, in a 1:2 molar ratio, were used.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

### EXAMPLE 4

In this example, 150 mg of dried and ground citrus pulp and 1.5 g DES choline chloride combined with glycolic acid, in a 1:1 molar ratio, were used.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

### EXAMPLE 5

In this example, 150 mg of dried and ground citrus pulp and 1.5 g of choline glycolate were used.

### Step A:

preparation of 150 mg of dried and ground citrus pulp;
mixing of ionic solvent with citrus pulp for 24 hours at 25° C.;
centrifugation of the mixture and obtaining a precipitate of cellulose and a mixture of ionic solvent, pectin, hemicellulose.

### Step B:

separation of precipitated cellulose.

### Step D:

washing of the cellulose precipitate six times with water at 20° C. The mixture containing water and ionic solvent is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing ionic solvent, pectin, hemicellulose;
separation of pectin and precipitated hemicellulose.

### EXAMPLE 6

In this example, 150 mg of dried and ground citrus pulp and 1.5 g DES choline chloride combined with levulinic acid, in a 1:1 molar ratio, were used.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

### EXAMPLE 7

In this example, 150 mg of dried and ground citrus pulp and 1.5 g DES choline acetate combined with diglycolic acid, in a 1:1 molar ratio, were used.

### Step A:

preparation of 150 mg of dried and ground citrus pulp;
mixing of DES with citrus pulp for 24 hrs at 25° C.;
centrifugation of the mixture and obtaining a precipitate of cellulose and a mixture of DES, pectin, hemicellulose.

### Step B:

separation of precipitated cellulose.

### Step D:

washing of the cellulose precipitate six times with water at 20° C. The mixture containing water and DES is used in step C of the process;
centrifugation of the aqueous mixture;
separation of the cellulose from the aqueous mixture resulting in cellulose with a higher degree of crystallinity than the starting biomass.

### Step C:

addition of a certain amount of ethanol equal to 10 ml to the mixture containing DES, pectin, hemicellulose;
separation of pectin and precipitated hemicellulose.

1. Process for the treatment of biomass consisting of dried and pulverized citrus pulp, said process comprising the following steps:
A. mixing the biomass with a process solvent selected from a eutectic solvent consisting of a hydrogen bond acceptor and a hydrogen bond donor, an ionic liquid and a mixture of said eutectic solvent and said ionic solvent, and precipitating cellulose residues;
B. separating the insoluble cellulose residues precipitated in step A;
C. separating the hemicellulose and the pectin from the process solvent;
wherein step C. of the separation of hemicellulose and pectin is performed through the addition of a lower alcohol and water, thus allowing the precipitation of the hemicellulose and the pectin and their subsequent separation with conventional techniques from the liquid phase comprising process solvent, organic solvent and possibly water.

2. Process according to claim 1, wherein the hydrogen bond acceptor is selected from choline acetate and choline chloride and the hydrogen donor bond is selected from urea, citric acid, glycolic acid, diglycolic acid, levulinic acid.

3. Process according to claim 2, wherein ionic liquid is the product resulting from the reaction of:
choline Y⁻+X—H=choline X⁻+Y—H
where X is the anion of a weak organic acid selected from glycolic acid, citric acid, diglycolic acid, levulinic acid, whereas Y is selected from CH₃COO⁻ and Cl⁻.

4. Process according to claim 1, wherein in the DES the weight ratio between the hydrogen bond acceptor and the hydrogen bond donor of the eutectic solvent is at least 1:5 to 5:1.

5. Process according to claim 1, wherein the process comprises a step D. in which the precipitate separated in step B. is washed with water to remove the traces of DES and/or ionic liquid.

6. Process according to claim 5, wherein step D. is repeated 6 times.

7. Process according to claim 5, wherein the aqueous mixture coming from step D. and comprising process solvent and water is recycled to step A. or to the mixture comprising the process solvent coming from step B.

8. Process according to claim 1, wherein the process is performed at a temperature comprised between 20 and 100° C.

9. Process according to claim 1, wherein the mixing temperature of the process solvent in step A. is at least in a range comprised between 15 and 60° C.

10. Process according to claim 1, wherein the lower alcohol is a linear or branched C₁-C₄ aliphatic alcohol.

11. Process according to claim 1, wherein the hydrogen bond acceptor is choline acetate and the hydrogen bond donor is glycolic acid.

12. Process according to claim 1, wherein in the DES the weight ratio between the hydrogen bond acceptor and the hydrogen bond donor of the eutectic solvent is 1:2 to 2:1.

13. Process according to claim 1, wherein in the DES the weight ratio between the hydrogen bond acceptor and the hydrogen bond donor of the eutectic solvent is 1:1.

14. Process according to claim 1, wherein the mixing of the process solvent in step A. is performed at a temperature between 20 and 40° C.

15. The process according to 1, wherein the mixing of the process solvent in step A. is performed at 20° C.

16. Process according to claim 1, wherein the lower alcohol is ethanol or isopropanol.
